(19) United States
(12) Patent Application Publication
(10) Pub. No.: US 2025/0142002 A1
(43) Pub. Date: May 1, 2025

(54) INFORMATION SYSTEM, NON-TRANSITORY COMPUTER READABLE MEDIUM, AND INFORMATION PROCESSING METHOD

(71) Applicant: Fujifilm Business Innovation Corp., Tokyo (JP)

(72) Inventor: Hiroki TSUJINAKA, Kanagawa (JP)

(73) Assignee: Fujifilm Business Innovation Corp., Tokyo (JP)

(21) Appl. No.: 18/635,803

(22) Filed: Apr. 15, 2024

(30) Foreign Application Priority Data
Oct. 30, 2023 (JP) 2023-185985

(51) Int. Cl. H04N 1/00

(52) U.S. Cl. CPC H04N 1/00084; H04N 1/00037; H04N 2201/0094

(57) ABSTRACT

An information system includes a processor, in which, when an abnormality has been detected in a program that the system itself possesses, the processor refers to, among restoration programs for the program that the system itself or each of available other systems for the system itself possesses, a latest one of the restoration programs, and replaces the program that the system itself possesses with the latest one of the restoration programs.

### CROSS-REFERENCE TO RELATED APPLICATIONS

This application is based on and claims priority under 35 USC 119 from Japanese Patent Application No. 2023-185985 filed Oct. 30, 2023.

### BACKGROUND

### (i) Technical Field

The present disclosure relates to an information system, a non-transitory computer readable medium, and an information processing method.

### (ii) Related Art

For example, Japanese Unexamined Patent Application Publication No. 2019-075000 discloses an information processing apparatus that sequentially activates a plurality of modules subsequent to activation of a boot program, in which, in the information processing apparatus, each of the modules includes detection means that uses verification information for verifying a signature of one of the modules, which is to be activated next, to detect tampering of the one of the modules, which is to be activated next, and activation means that activates the one of the modules, which is to be activated next, when verification of the signature by the detection means is successful, and each of the modules is holding the verification information and its own signature in advance.

### SUMMARY

Aspects of non-limiting embodiments of the present disclosure relate to an information system, a program, and an information processing method that, when there are limited sources of a restoration program available for a program that the system itself possesses, improve safety after the program that the system itself possesses has been replaced with the restoration program.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information system including a processor configured to, when an abnormality has been detected in a program that the system itself possesses, refer to, among restoration programs for the program that the system itself or each of available other systems for the system itself possesses, a latest one of the restoration programs, and replace the program that the system itself possesses with the latest one of the restoration programs.

### BRIEF DESCRIPTION OF THE DRAWINGS

An exemplary embodiment of the present disclosure will be described in detail based on the following figures, wherein:

FIG. 1 is a front cross-sectional diagram illustrating an image forming apparatus according to an exemplary embodiment of the present disclosure;

FIG. 2 is a block diagram illustrating a functional configuration of a control portion according to the exemplary embodiment of the present disclosure;

FIG. 3 is a diagram illustrating a state in which the image forming apparatuses according to the exemplary embodiment of the present disclosure are coupled to a network;

FIG. 4 is a flowchart illustrating a procedure in which the control portion according to the exemplary embodiment of the present disclosure replaces a program;

FIG. 5 is a diagram illustrating a procedure in which the control portion according to the exemplary embodiment of the present disclosure replaces a program, and is a diagram illustrating a list of pieces of address information including versions of restoration programs stored in the other image forming apparatuses and states of the other image forming apparatuses, which are acquired by the control portion;

FIG. 6 is a diagram illustrating, subsequent to FIG. 5, the procedure in which the control portion according to the exemplary embodiment of the present disclosure replaces the program, and is a diagram illustrating a result of sorting, in the list, the pieces of address information in such an order that a latest version of the restoration program comes top; and

FIG. 7 is a diagram illustrating, subsequent to FIG. 6, the procedure in which the control portion according to the exemplary embodiment of the present disclosure replaces the program, and is a diagram illustrating a result after a top record in the list of the pieces of address information has been removed until one of the image forming apparatuses, which is not in processing operation, comes top in the list of the pieces of address information.

### DETAILED DESCRIPTION

Hereinafter, an example of an exemplary embodiment of the present disclosure will be described with reference to the drawings. Note that, in the drawings, the same or equivalent components and parts are denoted by the same reference signs. Furthermore, dimensional ratios in the drawings are exaggerated for convenience of description and may be different from actual ratios.

Note that, in the following description, a user refers to a person who uses an image forming apparatus 10, and a number of the persons is not limited.

### (Image Forming Apparatus 10)

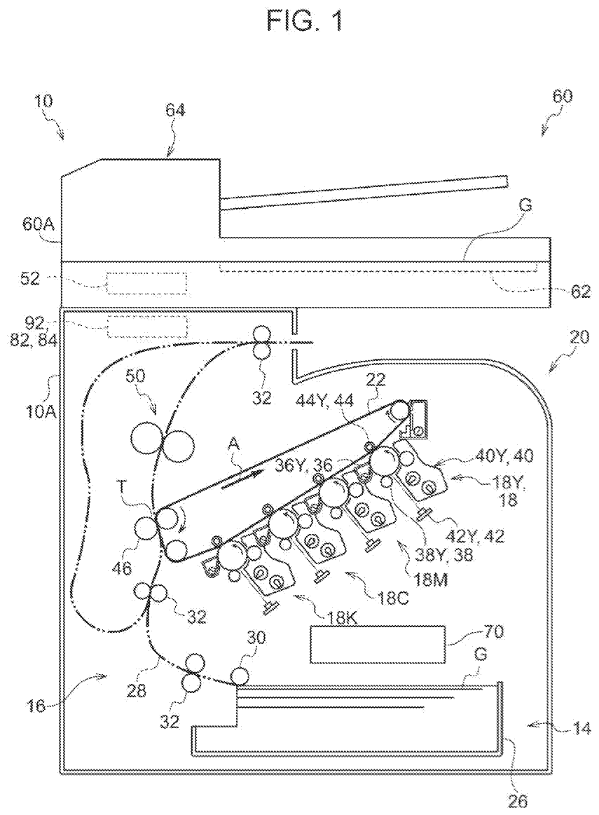

The image forming apparatus 10 illustrated in FIG. 1 is an example of an “image forming system” according to the present exemplary embodiment. The image forming apparatus 10 is a so-called multifunction printer (MFP), and has a function of receiving a print job and forming an image on a document G, and a function of reading an image from the document G as image data. Furthermore, the image forming apparatus 10 further has a mail function of attaching, to an electronic mail, and transmitting image data to another image forming apparatus 10, and a facsimile function of using a facsimile line to transmit the image data. As illustrated in FIG. 1, the image forming apparatus 10 includes, from bottom to top, an image forming portion 20 that forms an image on a document G and a document reading portion 60 that reads an image formed on a document G. Furthermore, the image forming apparatus 10 includes a control portion 70 that controls the image forming portion 20 and the document reading portion 60, and a touch panel 92 that displays a state of the image forming apparatus 10. Note that the document G is an example of a “recording medium” according to the present exemplary embodiment.

### (Image Forming Portion 20)

The image forming portion 20 includes image forming units 18, an accommodation portion 14, and a conveyance portion 16. The image forming units 18, the accommodation portion 14, and the conveyance portion 16 are stored in a housing 10A of the image forming apparatus 10.

The image forming portion 20 includes four image forming units 18Y, 18M, 18C, and 18K for yellow (Y), magenta (M), cyan (C), and black (K), respectively. Note that, in the following description, when it is not necessary to distinguish Y, M, C, and K from each other for description, Y, M, C, and K may be omitted.

It is possible to attach and detach the image forming units 18 for the colors to and from the housing 10A, respectively. Then, the image forming units 18 for the colors each include an image holding body 36, a charging roll 38 that causes a surface of the image holding body 36 to be charged, and an exposure device 42 that causes the image holding body 36 that has been charged to be irradiated with exposure light. In addition, the image forming units 18 for the colors are each provided with a developing device 40 that develops and visualizes, as a toner image, an electrostatic latent image formed as the exposure device 42 described above has caused the image holding body 36 that has been charged to be exposed with exposure light.

Furthermore, the image forming portion 20 includes a transfer belt 22 that has an endless shape and that rotates in a direction of an arrow A in FIG. 1, and primary transfer rolls 44 that transfer toner images formed by the image forming units 18 for the colors to the transfer belt 22. In addition, the image forming portion 20 includes secondary transfer rolls 46 that transfer the toner images transferred to the transfer belt 22 to a document G, and a fixing device 50 that heats and pressurizes the document G to which the toner images have been transferred to fix the toner images to the document G.

The primary transfer rolls 44 cause the toner images formed on the surfaces of the image holding bodies 36 for the colors to be transferred to the transfer belt 22. Furthermore, the toner images on a surface of the transfer belt 22 are transferred to the document G at a transfer position T.

The accommodation portion 14 is provided with an accommodation member 26 that is able to be withdrawn from the housing 10A of the image forming apparatus 10 toward a front side in a depth direction of the apparatus, and documents G are stacked in the accommodation member 26. In addition, the accommodation portion 14 is provided with a sending roll 30 that sends a top one of the documents G loaded in the accommodation member 26 to a conveyance path 28 configuring the conveyance portion 16.

The conveyance portion 16 includes a plurality of conveying rolls 32 that convey a document G along the conveyance path 28. The document G sent from the accommodation member 26 to the conveyance path 28 by the sending rolls 30 is sent to the transfer position T where the transfer belt 22 and the secondary transfer rolls 46 are in contact with each other. As the document G is conveyed between the transfer belt 22 and one of the secondary transfer rolls 46, the toner images are transferred to the document G.

The fixing device 50 causes the toner images transferred to the document G to be fixed to the document G. Then, the conveying rolls 32 cause the document G on which the toner images have been fixed to be discharged to outside of the housing 10A.

Note that a configuration and specific functions of the control portion 70 included in the image forming apparatus 10 will be described later.

### (Document Reading Portion 60)

The document reading portion 60 is an example of a reading device according to the present exemplary embodiment, and includes a transparent plate 62 (so-called platen glass) on which, when an image on a single document G is to be read, the document G is placed. Then, the transparent plate 62 is fitted into an upper portion of a housing 60A of the document reading portion 60.

An opening-and-closing cover for opening or closing the transparent plate 62 is disposed above the transparent plate 62. Then, inside the opening-and-closing cover, a conveyance device 64 (a so-called auto document feeder (ADF) device) that conveys a plurality of documents G along the conveyance path 28 inside the opening-and-closing cover is provided.

Furthermore, inside the housing 60A, an image reading device 52 that reads an image on a document G placed on the transparent plate 62 and that reads an image on a document G conveyed to a document reading position R by the conveyance device 64 is provided. The document reading portion 60 reads an image on a document G and generates image data based on control of the control portion 70. That is, a combination of the control portion 70 and the document reading portion 60 is an example of a “document reading system” according to the present exemplary embodiment.

### (Touch Panel 92)

The touch panel 92 is a device that displays a state of the image forming apparatus 10 and the like based on control of the control portion 70, and is an example of an “indicating portion” according to the present exemplary embodiment. The touch panel 92 is possible to indicate a state of the image forming apparatus 10 and to receive an operation by the user, and functions as a user interface of the image forming apparatus 10. That is, the touch panel 92 according to the present exemplary embodiment functions as both a “display portion 82” and a “reception portion 84” according to the present exemplary embodiment. Furthermore and in other words, the touch panel 92 is also an example of a part of an “information processing system” according to the present exemplary embodiment. Note that the touch panel 92 may be disposed at a desired position, but, as illustrated in FIG. 1, as an example, is disposed on a front surface of the housing 10A of the image forming apparatus 10.

### (Control Portion 70)

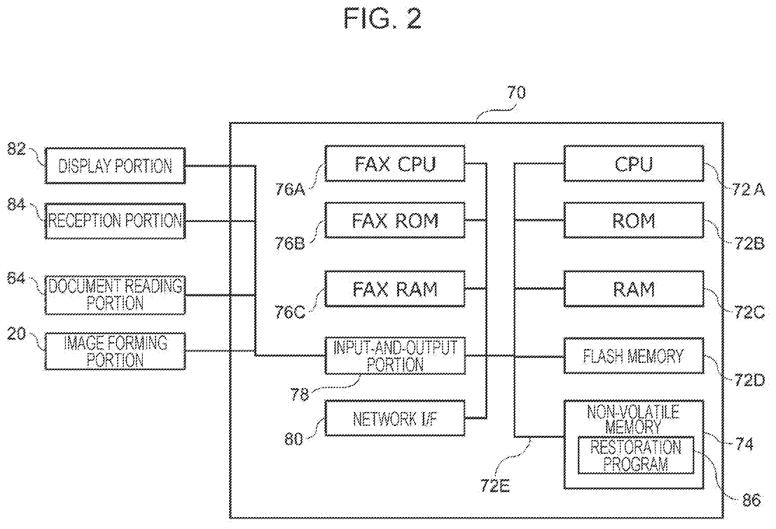

The control portion 70 is an example of the “information processing system” according to the present exemplary embodiment, and, as illustrated in FIG. 2, includes a central processing unit (CPU) 72A and a random access memory (RAM) 72C used as a temporary working region for the CPU 72A. Note that the CPU 72A is an example of a “processor” according to the present exemplary embodiment. Furthermore, the control portion 70 includes a read only memory (ROM) 72B, a flash memory 72D, a non-volatile memory 74 that stores a control program causing the control portion 70 to function, and an input-and-output portion 78. Furthermore, the control portion 70 according to the present exemplary embodiment further includes a facsimile CPU 76A, a facsimile ROM 76B, and a facsimile RAM 76C. These various components are coupled to the input-and-output portion 78 and a network interface (hereinafter referred to as a “network I/F 80”) via a bus 72E.

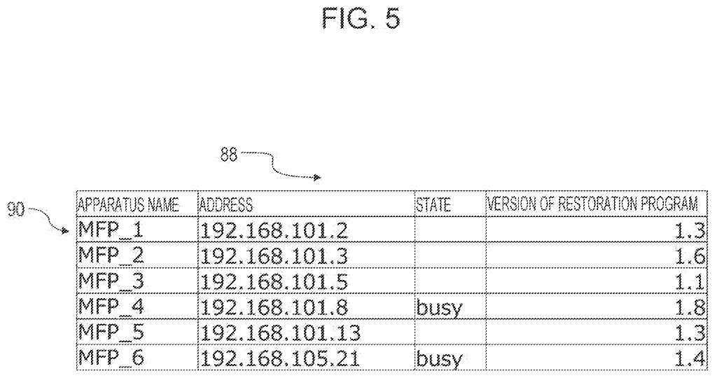

Note that a list 88 of pieces of address information is stored in the RAM 72C, which is an example of a “list of available information systems” in a procedure of replacing a program, described later (see also FIG. 5). A name of an image forming apparatus 10, with which communication has been performed, its network address, its state, and its version of a restoration program 86 are stored in the list 88 of the pieces of address information.

Furthermore, the CPU 72A in the control portion 70 reads the control program that is an example of a “program” according to the present exemplary embodiment from the ROM 72B, and executes entire control of the image forming apparatus 10 borne by the control portion 70. Specifically, as illustrated in FIG. 2, the touch panel 92, the document reading portion 60, and the image forming portion 20 included in the image forming apparatus 10 are coupled to the input-and-output portion 78 in the control portion 70. Thereby, the CPU 72A in the control portion 70 controls the components including the touch panel 92, the document reading portion 60, and the image forming portion 20.

The non-volatile memory 74 is an example of a storage device in which stored information is maintained even when power supplied to the components is cut off, for which a semiconductor memory is used, but a hard disk may be used, for example. Furthermore, the restoration program 86 that will be described later is recorded in the non-volatile memory 74.

The facsimile CPU 76A, the facsimile ROM 76B, and the facsimile RAM 76C are identical in specific configuration to the CPU 72A, the ROM 72B, and the RAM 72C, respectively. When the CPU 72A transmits image data stored in the RAM 72C to another apparatus, the facsimile CPU 76A serves as a facsimile to play a role of transmitting the image data as image information to the other apparatus via a facsimile line (e.g., a telephone line).

More specifically, when an instruction has been received from the CPU 72A, the facsimile CPU 76A reads a program for transmitting image data from the facsimile ROM 76B through the facsimile line, uses the facsimile line, and transmits the image data to another apparatus.

Note that, if there is an abnormality in the program that the facsimile CPU 76A executes (for example, if the program has been tampered), the CPU 72A transfers the restoration program 86 stored in the non-volatile memory 74 to the facsimile ROM 76B. Thereby, the CPU 72A replaces the program recorded in the facsimile ROM 76B with the restoration program 86 to restore the facsimile function.

### (Network Coupling)

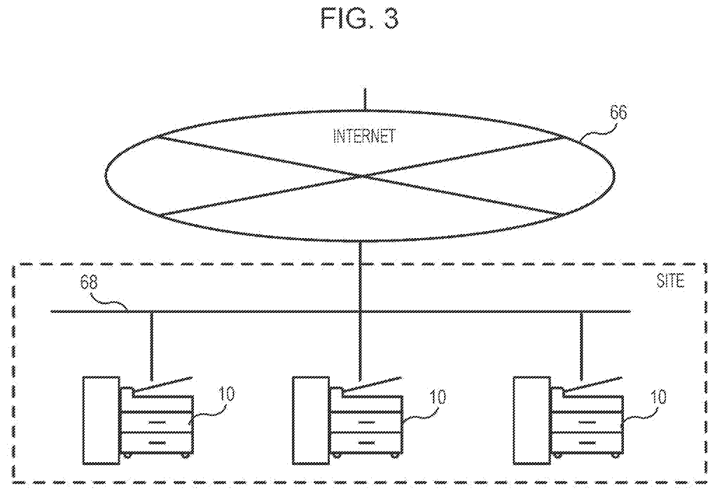

A plurality of the image forming apparatuses 10 according to the present exemplary embodiment are disposed in a site as illustrated in FIG. 3. More specifically, the plurality of image forming apparatuses 10 disposed in the site are coupled to each other via an internal network such as a local area network (LAN), and, furthermore, the image forming apparatuses 10 are each coupled to an Internet 66. Note that, in the following description, a specific one of the image forming apparatuses 10 may be referred to as an “apparatus itself”, and another one of the image forming apparatuses 10, which is different from the apparatus itself, may be referred to as “another apparatus”. That is, the “apparatus itself” and the “other apparatus” are examples of a “system itself” and “another system” according to the present exemplary embodiment, respectively.

Furthermore, there may be cases where the CPU 72A is coupled to a non-illustrated server via the Internet 66 to download and upgrade the restoration program 86. In other words, the CPU 72A may update the restoration program 86 stored in the non-volatile memory 74.

Note that, as illustrated in FIG. 3, the plurality of image forming apparatuses 10 are identical to each other in configuration. Thereby, versions of a non-illustrated program that the CPU 72A executes, a non-illustrated program that the facsimile CPU 76A executes, and the restoration program 86 may be different among the image forming apparatuses 10.

Furthermore, the CPU 72A may receive inquiries about a version of the restoration program 86 that the apparatus itself possesses and a state of the apparatus itself from another apparatus via the internal network. When an inquiry has been received from another apparatus, the version of the restoration program 86 that the apparatus itself possesses is responded to the other apparatus that has made the inquiry. Note that a state of the apparatus itself includes, as an example, a case where the image forming apparatus 10 is executing a print job.

### (Abnormality in Facsimile Transmission Program)

Incidentally, there may be an assumed case where an abnormality occurs due to some reasons such as unauthorized access to a program that the facsimile CPU 76A executes and the control portion 70 faces difficulties in transmitting image data using the facsimile line. In such a situation, a network administrator at the site disconnects coupling of the network inside the site to the Internet 66 and then attempts to restore the network inside the site. In other words, the image forming apparatus 10 may restore the facsimile function in a state where the coupling to the Internet 66 is disconnected.

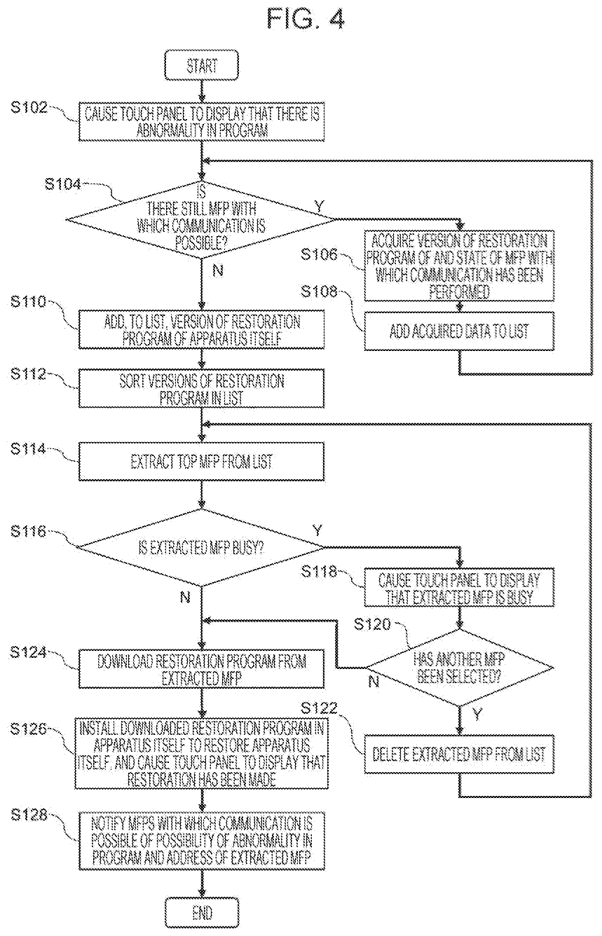

Note herein that, when an abnormality has occurred in a program that the facsimile CPU 76A executes, the CPU 72A in the image forming apparatus 10 according to the present exemplary embodiment replaces the program with another program based on a procedure illustrated in FIG. 4 based on the control program. In other words, the CPU 72A executes the procedure illustrated in FIG. 4 when an abnormality has been detected in a program that the apparatus itself possesses.

### (Procedure of Replacing Program)

In step S102, the CPU 72A first causes the touch panel 92 to display that there is an abnormality in a program that the facsimile CPU 76A executes. Then, the CPU 72A proceeds to step S104.

Next, in step S104, the CPU 72A checks whether or not there is one among the image forming apparatuses 10, with which the apparatus itself is able to communicate. More specifically, in step S104, the CPU 72A attempts to communicate with each of the image forming apparatuses 10 coupled to the network in the site. Then, when a positive determination is made in step S104, that is, when there is one among the image forming apparatuses 10, with which communication is possible, the CPU 72A proceeds to step S106. On the other hand, in step S104, when it is impossible to communicate with one among the image forming apparatuses 10, including a case where communication is attempted with all the image forming apparatuses 10 in the network in the site, the CPU 72A proceeds to step S110.

Next, in step S106, the CPU 72A acquires versions of the restoration program 86 that the image forming apparatuses 10 with which communication has been performed have stored in the non-volatile memories 74, respectively, and states of the image forming apparatuses 10 with which communication has been performed. Note that one among the image forming apparatuses 10, with which communication has been performed, in which a processing operation is being performed, such as a print job is being executed, responds with “Busy” as the state of the image forming apparatus 10. Then, the CPU 72A proceeds to step S108.

Next, in step S108, the CPU 72A adds, to the list 88 of the pieces of address information, records 90 including the versions of the restoration program 86 that the other apparatuses possess and the states of the image forming apparatuses 10, which have been acquired. More specifically, as illustrated in FIG. 5, the records 90 including names of the image forming apparatuses 10, with which communication has been performed, their network addresses, and their states, and their versions of the restoration program 86 are added to the list 88 of the pieces of address information. Then, the CPU 72A proceeds to step S104.

Note that, in step S110, the CPU 72A adds, to the list 88 of the pieces of address information, a record 90 including the name of the apparatus itself, its network address, its state, and its version of the restoration program 86. Then, the CPU 72A proceeds to step S112.

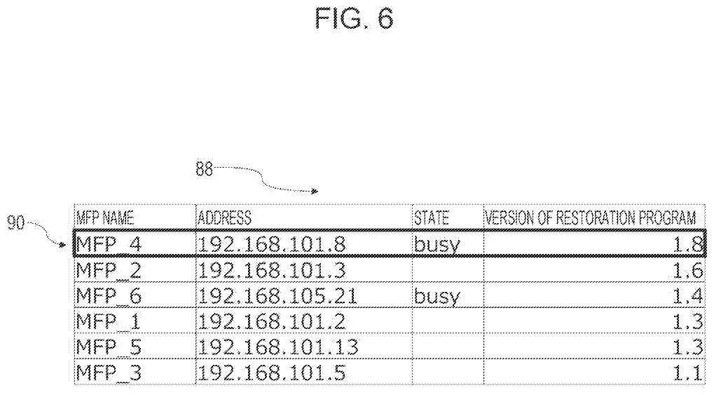

Next, in step S112, the CPU 72A rearranges (sorts) the pieces of address information in the list 88 based on the versions of the restoration program 86. More specifically, as illustrated in FIG. 6, the CPU 72A rearranges the records 90 in such an order that a greater version of the restoration program 86 comes top (in such an order that a latest version of the restoration program 86 comes top). Then, the CPU 72A proceeds to step S114.

Next, in step S114, the CPU 72A extracts the top one of the pieces of address information of the image forming apparatuses 10 from the list 88 of the pieces of address information. For example, in FIG. 6, the CPU 72A extracts the address information of “MFP_4” surrounded by a thick frame. Then, the CPU 72A proceeds to step S116.

Next, in step S116, the CPU 72A determines whether or not the state of the multifunction machine, which is extracted in step S114, is “Busy”. Then, when a positive determination is made in step S116, the CPU 72A proceeds to step S118. On the other hand, when a negative determination is made in step S116, the CPU 72A proceeds to step S124.

Furthermore, in step S118, the CPU 72A causes the touch panel 92 to display that the image forming apparatus 10 possessing the latest version of the restoration program 86 is in processing operation. Then, the CPU 72A proceeds to step S120.

Next, in step S120, the CPU 72A receives an instruction from the user as to whether or not to select another one of the image forming apparatuses 10 than the image forming apparatus 10 that has been extracted in step S114. In other words, the CPU 72A receives an instruction from the user as to whether or not to wait for completion of execution of the processing operation by the image forming apparatus 10 that has been extracted in step S114. Furthermore and in other words, in step S120, the CPU 72A determines whether or not to remove the record 90 from the list 88 of the pieces of address information based on a result of reception from the user. Then, when a positive determination is made in step S120, the CPU 72A proceeds to step S122. On the other hand, when a negative determination is made in step S120, the CPU 72A proceeds to step S124.

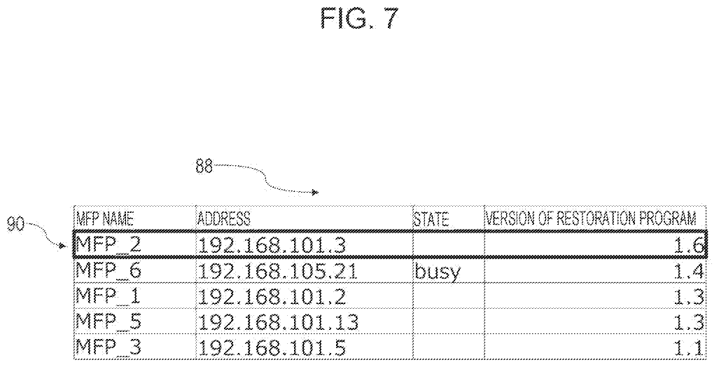

Next, in step S122, as illustrated in FIG. 7, the CPU 72A removes the record 90 at the top in the list 88 of the pieces of address information. Then, the CPU 72A proceeds to step S114.

Note that, in step S124, the CPU 72A acquires the restoration program 86 from the image forming apparatus 10 that has been extracted in step S114. In other words, the CPU 72A transfers the restoration program 86 that the image forming apparatus 10 that has been extracted in step S114 possesses to the RAM 72C. For example, when the image forming apparatus 10 that has been extracted in step S114 is another apparatus, the CPU 72A acquires the restoration program 86 via the network. Furthermore, for example, when the image forming apparatus 10 that has been extracted in step S114 is the apparatus itself, the CPU 72A transfers the restoration program 86 stored in the non-volatile memory 74 in the apparatus itself to the RAM 72C. Then, the CPU 72A proceeds to step S126.

Next, in step S126, the CPU 72A replaces the restoration program 86 transferred to the RAM 72C with the program (the program in which the abnormality has occurred) stored in the facsimile ROM 76B to restore the facsimile function. Furthermore, in step S126, the CPU 72A causes the touch panel 92 to display that restoration from the abnormality has been made. Then, the CPU 72A proceeds to step S128.

Next, in step S128, the CPU 72A notifies the image forming apparatuses 10 included in the list 88 of the pieces of address information of a possibility of an abnormality in the program that the facsimile CPU 76A executes. Furthermore, in step S128, the CPU 72A notifies the image forming apparatuses 10 included in the list 88 of the pieces of address information of the address of the image forming apparatus 10 possessing the latest version of the restoration program 86, regarding the program that the facsimile CPU 76A executes. Note that the image forming apparatus 10 possessing the latest version of the restoration program 86 is an example of a “first system” according to the present exemplary embodiment. Furthermore, the image forming apparatuses 10 possessing other versions of the restoration program 86 than the latest version among the image forming apparatuses 10 possessing the restoration program 86 are examples of “second systems” according to the present exemplary embodiment. Then, the CPU 72A completes a series of the procedure.

Note that, in step S128, the image forming apparatuses 10 that have been notified of a possibility of an abnormality inspect whether or not an abnormality has occurred in the program that the CPUs 76A in the image forming apparatuses 10 execute. Then, the CPUs 76A in the image forming apparatuses 10, when determining that an abnormality has occurred in the program that the CPUs 76A in the image forming apparatuses 10 execute, execute the procedure illustrated in FIG. 4. That is, in step S128, when viewed from the image forming apparatuses 10 that have received the notification of a possibility of an abnormality, the image forming apparatuses 10 are other examples than the “apparatus itself” according to the present exemplary embodiment.

However, in step S128, the image forming apparatuses 10 that have been notified of a possibility of an abnormality may omit step S104 to step S116 in the procedure illustrated in FIG. 6. In other words, in step S128, the image forming apparatuses 10 that have received the notification of a possibility of an abnormality may acquire the restoration program 86 from the image forming apparatus 10 possessing the latest version of the restoration program 86 without confirming whether or not there is one of the image forming apparatuses 10, with which the apparatus itself is able to communicate.

Furthermore, in step S128, the CPU 72A in the apparatus itself may cause the image forming apparatuses 10 that have been notified of a possibility of an abnormality to inspect whether or not an abnormality has occurred in the program that the CPUs 76A in the image forming apparatuses 10 execute. In other words, in step S128, the CPU 72A in the apparatus itself may cause the image forming apparatuses 10 that have been notified of a possibility of an abnormality to start inspection, or the CPU 72A in the image forming apparatus 10 may determine and start the inspection.

Next, workings and effects of the image forming apparatus 10 according to the present exemplary embodiment will now be described herein.

### (Workings and Effects)

When an abnormality has been detected in a program that the apparatus itself possesses, the control portion 70 according to the present exemplary embodiment refers to, among the restoration programs 86 for the program that the apparatus itself or each of the available other ones of the apparatuses for the apparatus itself possesses, a latest one of the restoration programs 86, and replaces the program that the apparatus itself possesses with the latest one of the restoration programs. Thereby, when there are limited sources of the restoration program 86 available for the program that the apparatus itself possesses, it is possible to improve safety after the program that the system itself possesses has been replaced with the restoration program, compared with a case where the program that the apparatus itself possesses is always replaced with the restoration program 86 that the apparatus itself possesses.

Furthermore, when detecting that the image forming apparatus 10 possessing the latest version of the restoration program 86 is in processing operation, the control portion 70 according to the present exemplary embodiment determines whether or not to exclude the image forming apparatus 10 from the list 88 of the pieces of address information. Thereby, when the image forming apparatus 10 possessing the latest version of the restoration program 86 is in processing operation, it is possible to refer to the restoration program 86 from another one of the image forming apparatuses 10, compared with a case of waiting for completion of the processing operation by the image forming apparatus 10. Furthermore and thereby, when the image forming apparatus 10 possessing the latest version of the restoration program 86 is in processing operation, it is possible to leave a possibility that the program that the apparatus itself possesses is replaced at an early stage, compared with a case of waiting for completion of the processing operation by the image forming apparatus 10.

Furthermore, the control portion 70 according to the present exemplary embodiment further includes the reception portion 84, and the CPU 72A determines, based on a result of reception by the reception portion 84, whether or not to exclude the image forming apparatus 10 from the list 88 of the pieces of address information. Thereby, when the program that an apparatus itself possesses is to be replaced with the restoration program 86, the user of the apparatus itself is able to determine degrees of priority between improvement of safety after replacement and shortening of a period of replacement time.

Furthermore, the control portion 70 according to the present exemplary embodiment notifies the other ones of the image forming apparatuses 10 than the image forming apparatus 10 of address information of the image forming apparatus 10 possessing the latest version of the restoration program 86. Thereby, it is possible to cause the other ones of the control portions 70, which are available for the apparatus itself, to recognize the control portion 70 possessing the latest version of the restoration program 86.

Furthermore, the control portion 70 according to the present exemplary embodiment further includes the touch panel 92, and, when an abnormality has been detected, the CPU 72A causes the touch panel 92 to display that the abnormality has been detected. Thereby, it is possible to notify the user using the apparatus itself of the abnormality in the program that the apparatus itself possesses.

Furthermore, the control portion 70 according to the present exemplary embodiment causes the touch panel 92 to display that the program has been replaced. Thereby, it is possible to notify the user using the apparatus itself that the abnormality occurred in the apparatus itself has been solved.

Furthermore, when an abnormality has been detected in a program that the apparatus itself possesses, the control portion 70 according to the present exemplary embodiment notifies the other ones of the apparatuses possessing the program of a possibility of the abnormality in the program. Thereby, it is possible to notify the other ones of the control portions 70 using the identical program to the program that the apparatus itself uses of a possibility of the abnormality in the program.

Furthermore, the combination of the control portion 70 and the document reading portion 60 according to the present exemplary embodiment includes the control portion 70 according to the present exemplary embodiment and the document reading portion 60 that reads an image recorded on a document G. Thereby, when there are limited sources of the restoration program 86 available for the program that the combination of the control portion 70 and the document reading portion 60 possesses, it is possible to improve safety after the program that apparatus itself possesses has been replaced with the restoration program 86.

Furthermore, the image forming apparatus 10 according to the present exemplary embodiment includes the image forming apparatus 10, the document reading system, and the image forming portion 20 that forms an image on a document G. Thereby, when there are limited sources of the restoration program 86 available for the program that the image forming apparatus 10 possesses, it is possible to improve safety after the program that the apparatus itself possesses has been replaced with the restoration program 86.

Furthermore, when an abnormality has been detected in the program that the apparatus itself possesses, the control program that the CPU 72A according to the present exemplary embodiment executes causes a computer to execute a process of referring to, among the restoration programs 86 for the program that the apparatus itself or each of the available other ones of the apparatuses for the apparatus itself possesses, a latest one of the restoration programs 86, and of replacing the program that the apparatus itself possesses with the latest one of the restoration programs. Thereby, when there are limited sources of the restoration program 86 available for the program that the apparatus itself possesses, it is possible to acquire the program that improves safety after the program that the apparatus itself possesses has been replaced with the restoration program 86, compared with a case where the program that the apparatus itself possesses is always replaced with the restoration program 86 that the apparatus itself possesses.

### Modification Examples

Note that, although, in the above description, when it is detected in step S116 that the image forming apparatus 10 possessing the latest version of the restoration program 86 is in processing operation, the CPU 72A has proceeded to step S118, the technique according to the present exemplary embodiment is not limited to the description. For example, such an aspect may be applied that, regardless of whether or not the image forming apparatus 10 possessing the latest version of the restoration program 86 is in processing operation, the restoration program 86 is acquired from the image forming apparatus 10. In other words, in the above description, after step S114 in the procedure, the procedure may directly proceed to step S124 without performing determination in step S116.

Furthermore, although, in the above description, the CPU 72A has removed the image forming apparatus 10 that is in processing operation from the list 88 of the pieces of address information based on a result of a selection by the user in step S120, the technique according to the present exemplary embodiment is not limited to the description. For example, in step S120, the CPU 72A may not receive a result of a selection by the user. In other words, in step S120, the CPU 72A may proceed to step S124 without receiving a selection by the user, or may proceed to step S122.

Furthermore, although, in the above description, the CPU 72A notifies the image forming apparatus 10 included in the list 88 of the pieces of address information of address information of the image forming apparatus 10 possessing the latest version of the restoration program 86 in step S128, the technique according to the present exemplary embodiment is not limited to the description. For example, in step S128, the CPU 72A may not notify the other ones of the apparatuses of address information of the image forming apparatus 10 possessing the latest version of the restoration program 86.

Furthermore, although, in the above description, the CPU 72A has caused the touch panel 92 to display that there is an abnormality in a program in step S102, the technique according to the present exemplary embodiment is not limited to the description. For example, in step S102, the CPU 72A may not cause the touch panel 92 to display that there is an abnormality in a program.

Furthermore, although, in the above description, in step S126, the CPU 72A has caused the touch panel 92 to display that a program in which there had been an abnormality has been restored, the technique according to the present exemplary embodiment is not limited to the description. For example, in step S126, the CPU 72A may not cause the touch panel 92 to display that a program has been restored.

Furthermore, although, in the above description, in step S128, the CPU 72A has notified the image forming apparatuses 10 included in the list 88 of the pieces of address information of a possibility of an abnormality in the program, the technique according to the present exemplary embodiment is not limited to the description. For example, in step S128, the CPU 72A may not notify the other ones of the apparatuses of an abnormality in the program.

Even in these modification examples, it is possible to acquire identical workings and effects as those described above.

### Other Modification Examples

Note that, in the above description, the control portion 70 included in the image forming apparatus 10 has been described as an example of the information system, but the technique according to the present exemplary embodiment is not limited to the description. That is, as to the control portion 70, it is possible to apply the technique according to the present exemplary embodiment in a similar manner to a combination of the control portion 70 and the reading portion without including the image forming portion 20. Furthermore and in addition, the control portion 70 may be used for referring to a latest version of the restoration program 86 among the restoration programs 86 for the program that the apparatus itself or each of the available other ones of the apparatuses for the apparatus itself possesses and for replacing the program that the apparatus itself possesses with the latest version of the restoration program.

For example, although, in the above description, the CPU 72A in the control portion 70 has executed the procedure of replacing a program when there is an abnormality in the program that the facsimile CPU 76A executes, the facsimile CPU 76A in the control portion 70 may execute the procedure of replacing the program.

Furthermore, although, in the above description, the touch panel 92 has been presented as an example of the indicating portion, the technique according to the present disclosure is not limited to the description. For example, instead of a device having a screen such as the touch panel 92, an indication may be provided using a lighting device such as a rotating light or an indication may be provided using an acoustic device such as a buzzer, when it is detected that an abnormality has occurred in a program.

Furthermore, although, in the above description, the image forming portion 20 has formed a toner image on a document G, the technique according to the present disclosure is not limited to the description. For example, an inkjet method may be used to allow the image forming portion 20 to form an image on a document G.

While the exemplary embodiments of the present disclosure have been described with reference to the accompanying drawings, it is apparent that those skilled in the art to which the present disclosure pertains can conceive various modifications and applications within the scope of the technical idea described in the claims, and it is to be understood that these naturally belong to the technical scope of the present disclosure.

### APPENDIX

(((1)))

An information system including a processor configured to, when an abnormality has been detected in a program that the system itself possesses, the refer to, among restoration programs for the program that the system itself or each of available other systems for the system itself possesses, a latest one of the restoration programs, and replace the program that the system itself possesses with the latest one of the restoration programs.

(((2)))

The information system described in (((1))), in which, when detecting that different first system possessing the latest one of the restoration programs is in processing operation, the processor is configured to determine whether or not to exclude the different first system from the available other systems.

(((3)))

The information system described in (((2))),
further including a reception portion,
in which the processor is configured to determine, based on a result of reception by the reception portion, whether or not to exclude the different first system from the available other systems.
   (((4)))

The information system described in any one of (((1) (3))), in which the processor is configured to notify a different second system other than the different first system of address information of the first system possessing the latest one of the restoration programs.

(((5)))

The information system described in any one of (((1))) to (((4))),
further including an indicating portion,
in which, when the abnormality has been detected, the processor is configured to cause the indicating portion to indicate that the abnormality has been detected.
   (((6)

The information system described in (((5))), in which the processor is configured to cause the indicating portion to indicate that the program has been replaced.

(((7)))

The information system described in any one of (((1))) to ((((6))), in which, when an abnormality has been detected in the program that the system itself possesses, the processor is configured to notify another system possessing the program of a possibility of an abnormality in the program.

(((8)))

The information system described in (((1))), further including a reading device configured to read an image recorded on a recording medium.

(((9)

The information system described in (((8))), further including an image forming portion configured to form an image on the recording medium.

(((10)))

A non-transitory computer readable medium storing a program causing a computer to execute a process including:
when an abnormality has been detected in a program that an information system possesses, referring to, among restoration programs for the program that the system or each of available other systems for the system possesses, a latest one of the restoration programs; and
replacing the program that the system itself possesses with the latest one of the restoration programs.
   (((11)))

An information processing method including:
when an abnormality has been detected in a program that a system possesses, referring to, among restoration programs for the program that the system or each of available other systems for the system possesses, a latest one of the restoration programs; and
replacing the program that the system itself possesses with the latest one of the restoration programs.

What is claimed is:

1. An information system comprising a processor configured to, when an abnormality has been detected in a program that the system itself possesses, refer to, among restoration programs for the program that the system itself or each of available other systems for the system itself possesses, a latest one of the restoration programs, and replace the program that the system itself possesses with the latest one of the restoration programs.

2. The information system according to claim 1, wherein, when detecting that different first system possessing the latest one of the restoration programs is in processing operation, the processor is configured to determine whether or not to exclude the different first system from the available other systems.

3. The information system according to claim 2,
further comprising a reception portion,
wherein the processor is configured to determine, based on a result of reception by the reception portion, whether or not to exclude the different first system from the available other systems.

4. The information system according to claim 1, wherein the processor is configured to notify a different second system other than the different first system of address information of the first system possessing the latest one of the restoration programs.

5. The information system according to claim 1,
further comprising an indicating portion,
wherein, when the abnormality has been detected, the processor is configured to cause the indicating portion to indicate that the abnormality has been detected.

6. The information system according to claim 5, wherein the processor is configured to cause the indicating portion to indicate that the program has been replaced.

7. The information system according to claim 1, wherein, when an abnormality has been detected in the program that the system itself possesses, the processor is configured to notify another system possessing the program of a possibility of an abnormality in the program.

8. The information system according to claim 1, further comprising a reading device configured to read an image recorded on a recording medium.

9. The information system according to claim 8, further comprising an image forming portion configured to form an image on the recording medium.

10. A non-transitory computer readable medium storing a program causing a computer to execute a process comprising:
when an abnormality has been detected in a program that an information system possesses, referring to, among restoration programs for the program that the system itself or each of available other systems for the system possesses, a latest one of the restoration programs; and
replacing the program that the system possesses with the latest one of the restoration programs.

11. An information processing method comprising:
when an abnormality has been detected in a program that an information system possesses, referring to, among restoration programs for the program that the system or each of available other systems for the system possesses, a latest one of the restoration programs; and
replacing the program that the system itself possesses with the latest one of the restoration programs.
